(19) United States
(12) Patent Application Publication
(10) Pub. No.: US 2021/0013515 A1
(43) Pub. Date: Jan. 14, 2021

(54) CURRENT COLLECTOR, ELECTRODE PLATE, AND BATTERY CELL USING THE SAME

(71) Applicant: Ningde Amperex Technology Ltd., Ningde (CN)

(72) Inventors: Ying Shao, Ningde (CN); HONGMEI WEI, Ningde (CN); Li Xiang, Ningde (CN); Qiaoshu Hu, Ningde (CN)

(21) Appl. No.: 16/545,267

(22) Filed: Aug. 20, 2019

(30) Foreign Application Priority Data
Jul. 12, 2019 (CN) 201910629669.X

(51) Int. Cl. H01M 4/66; H01M 4/20; H01M 4/80; H01M 4/04; H01M 4/68

(52) U.S. Cl. CPC H01M 4/661; H01M 4/20; H01M 4/685; H01M 4/0409; H01M 4/80

(57) ABSTRACT

A current collector with electrode tab areas of reduced resistance includes a polymer layer and a first metal layer. The polymer layer includes a first surface and a second surface opposite to the first surface. The first metal layer is arranged on the first surface, and includes a first area and a second area coupled to the first area. In the direction of a thickness of the current collector, the thickness of the second area is greater than that of the first area. The present disclosure further provides an electrode plate and a battery cell using the current collector. Due to an increase of a thickness of the second area, a charge transfer resistance of the electrode tab is greatly reduced.

### FIELD

The subject matter herein generally relates to lithium batteries, and more particularly, to a current collector, an electrode plate using the current collector, and a battery cell using the electrode plate.

### BACKGROUND

Due to high energy density, high operating voltage, low self-discharge, small volume, and light weight, lithium batteries are widely used in consumer electronics. With the rapid development of electric vehicles and mobile devices, safety of such a lithium battery needs to be considered.

The lithium secondary battery may include a metal foil, such as a copper foil, an aluminum foil, a nickel foil, which is used as a current collector and conducts electrons. Present current collectors have a tri-layer structure including a first metal layer, a second metal layer, and a polymer layer sandwiched between the first metal layer and the second metal layer. This kind of current collector are characterized with improved safety and reduced weight. However, because a resistance of the current collector is much larger than that of a metal foil, multilayer electrode tabs are needed to be arranged in a battery cell to reduce the resistance of such a battery. The resistance of electrode tab areas of the electrode tabs accounts for 20% of the resistance of the battery cell, so a reduction in the resistance of the electrode tab area is greatly desired.

### SUMMARY

What is needed, is a current collector having a small resistance of electrode tab area, and an electrode plate and a battery cell both using the current collector.

The present disclosure provides a current collector comprising a polymer layer and a first metal layer. The polymer layer includes a first surface and a second surface opposite to the first surface. The first metal layer is arranged on the first surface, and the first metal layer includes a first area and a second area connected to the first area. In a direction of a thickness of the current collector, a thickness of the second area is greater than a thickness of the first area.

The first area of the current collector is configured for providing active materials, the second area of the current collector is configured to be cut into an electrode tab.

The present disclosure further provides an electrode plate including a current collector and a first active layer. The current collector includes a polymer layer comprising a first surface and a second surface opposite to the first surface, and a first metal layer arranged on the first surface and including a first area and a second area connected to the first area. The first active layer is arranged on the first area. In the direction of a thickness of the current collector, the thickness of the second area is greater than that of the first area.

The present disclosure further provides a battery cell including a first electrode plate, a second electrode plate, an separator arranged between the first electrode plate and the second electrode plate, a first electrode tab arranged on the second area of the first electrode plate, and a second electrode arranged on the second electrode plate. The first electrode plate and the second electrode plate are stacked or wound to form the battery cell. Wherein the first electrode plate includes a current collector and a first active layer. The current collector includes a polymer layer including a first surface and a second surface opposite to the first surface, and a first metal layer arranged on the first surface and including a first area and a second area connected to the first area. The first active layer being arranged on the first area. In the direction of a thickness of the current collector, the thickness of the second area is greater than that of the first area, the first electrode tab is arranged on the second area of the first electrode plate and is formed by cutting the second area.

By increasing a thickness of the second area having an electrode tab, a charge transfer resistance of the electrode tab can be reduced. Likelihood of breakage of the metal layer is reduced, and inconsistency of resistance of the metal layer is further reduced. The energy density loss is less than 0.5%.

### BRIEF DESCRIPTION OF THE DRAWINGS

Implementations of the present disclosure will now be described, by way of embodiments, with reference to the attached figures.

FIG. 1 is a cross-sectional view of an embodiment of a current collector.

FIG. 2 is a cross-sectional view of an embodiment of a positive electrode plate.

FIG. 3 is a cross-sectional view of another embodiment of a positive electrode plate.

FIG. 4 is a cross-sectional view of an embodiment of a negative electrode plate.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein, but are not to be considered as limiting the scope of the embodiments.

Implementations of the disclosure will now be described, by way of embodiments only, with reference to the drawings. It should be noted that non-conflicting details and features in the embodiments of the present disclosure may be combined with each other.

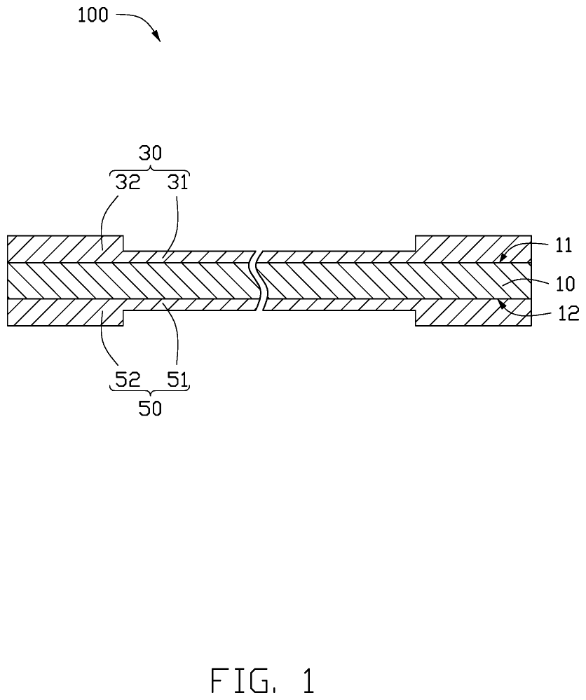

FIG. 1 illustrates an embodiment of a current collector 100 including a polymer layer 10 and a first metal layer 30. The polymer layer 10 includes a first surface 11 and a second surface 12 opposite to the first surface 11. The first metal layer 30 is arranged on the first surface 11. The first metal layer 30 includes a first area 31 and a second area 32 connected to the first area 31. The first area 31 is configured to be provided with an active material (not shown), either a positive material or a negative material. The second area 32 is configured to be provided with an electrode tab (not shown), which is configured to conduct electrons of the first metal layer 30. There are two second areas 32. The two second areas 32 are arranged on opposite sides of the first area 31. In an alternative embodiment, the second area 32 may be cut into the electrode tab. Furthermore, the second area 32 may comprise a plurality of sub-regions spaced from each other, the sub-regions may be cut into the electrode tabs.

In a direction of a thickness of the current collector 100, a thickness of the second area 32 is greater than a thickness of the first area 31. The thickness of the first area 31 is in a range from 0.1 mm to 5 mm, so that there is no loss of energy density in a main region of the battery cell including the current collector 100. The thickness of the second area 32 is in a range from 1 um to 20 um. In an alternative embodiment, the thickness of the first area 31 is in a range from 0.5 um to 3 um, the thickness of the second area 32 is in a range from 2 um to 8 um. Compared with a current collector having a traditional three-layer structure, the thickness of the second area 32 of the first metal layer 30 is greater than that of the first area 31. According to Ohm's law, a charge transfer resistance of the electrode tab arranged on the second area 32 is greatly reduced. Likelihood of breakage of the second area 32 with large thickness is reduced, and inconsistency of resistance of the first metal layer 30 is further reduced. Because the thickness of the second area 32 is increased and the thickness of an active material area is not increased, an energy density of a battery cell using an electrode plate of the present disclosure is less than 0.5%.

The polymer layer can be made of poly (butylene terephthalate), poly (ethylene naphthalate) (PEN), poly-ether-ether-ketone, polyimide, polyamide, polyethylene glycol, polyamide imide, polycarbonate, cyclic polyolefin, polyphenylene sulfide, polyvinyl acetate, poly tetra fluoroethylene, polynaphthylmethylene, polyvinylidene difluoride, poly (naphthalenedicarboxylicacid), poly propylene carbonate, poly (vinylidene difluoride-co-hexafluoropropylene), poly (vinylidene difluoride-co-chlorotrifluoroethylene), polysiloxane, vinylon, polypropylene, polyethylene, polyvinyl chloride, polystyrene, poly (cyanoarylether), polyurethane, polyphenylene oxide, polyester, polysulfone, and derivatives thereof.

The first metal layer 30 can be formed by sputtering, vacuum vapor deposition, ion plating, or pulse laser deposition. Since only the polymer layer 10 needs to be cut, metal burrs can be avoided, and the voltage drop per unit time (K value) is reduced, the safety of the battery is increased. The first metal layer 30 can be made of a material selected from a group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and any combination (alloy) thereof.

Furthermore, the current collector 100 further includes a second metal layer 50. The second metal layer 50 is arranged on the second surface 12 of the polymer layer 10. The second metal layer 50 includes a third area 51 and a fourth area 52 connected to the third area 51. Wherein, a position of the third area 51 corresponds to that of the first area 31, the position of the fourth area 52 corresponds to that of the second area 32. The third area 51 is used to be arranged with active material, the fourth area 52 is used to be arranged with electrode tab. There are two fourth areas 52, the two fourth areas 52 are arranged on opposite sides of the third area 51. In an alternative embodiment, the fourth area 52 may be cut to form the electrode tab; furthermore, the fourth area 52 may comprise a plurality of sub-regions spaced from each other, the sub-regions may be cut to form the electrode tabs.

In the direction of the thickness of the current collector 100, a thickness of the fourth area 52 is greater than a thickness of the third area 51. The thickness of the third area 51 is in a range from 0.1 um to 5 um, so that there is no loss of energy density in a main region of the battery cell comprising the current collector 100. The thickness of the fourth area 52 is in a range from 1 um to 20 um. In an alternative embodiment, the thickness of the third area 51 is in a range from 0.5 um to 3 um, the thickness of the fourth area 52 is in a range from 2 um to 8 um. The third area 51 and the first area 31 can have same or different thickness. The fourth area 52 and the second area 32 can have same or different thickness. In an alternative embodiment, the thickness of the third area 51 is the same as that of the first area 31, and the thickness of fourth area 52 is the same as that of the second area 32.

The second metal layer 50 can be formed by sputtering, vacuum vapor deposition, ion plating, or pulse laser deposition. The second metal layer 50 can be made of a material selected from a group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and any combination (alloy) thereof. The first metal layer 30 and the second metal layer 50 can be made of different materials. In an alternative embodiment, the first metal layer 30 is made of Cu, the second metal layer 50 is made of Al. That is, the current collector 100 has different materials on opposite surfaces of the polymer layer 10. In an alternative embodiment, the first metal layer 30 and the second metal layer 50 can also be made of the same material, for example, the first metal layer 30 and the second metal layer 50 are both made of Al.

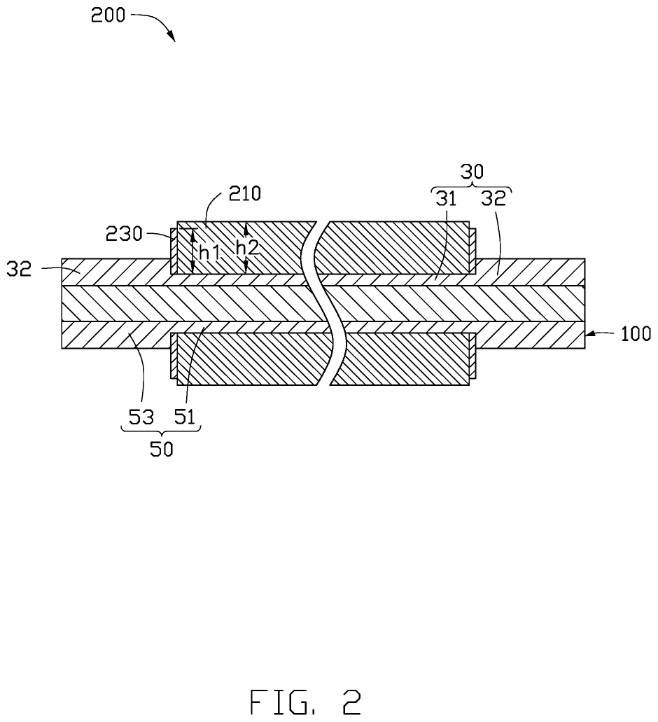

FIG. 2 illustrates an embodiment of a positive electrode plate 200 including the current collector 100 and a first active layer 210 arranged on a surface of the current collector 100. The first active layer 210 is a positive active material layer. The positive active material layer can be formed on the surface of the current collector 100 by processes including coating, drying, and cooling. The first active layer 210 is arranged on the first area 31 of the first metal layer 30.

Furthermore, the positive electrode plate 200 further includes an insulating layer 230 arranged on the surface of the current collector 100. The insulating layer 230 is arranged on a side of the first active layer 210 adjacent to the second area 32. In an alternative embodiment, the insulating layer 230 is arranged on the first area 31 and connected to an edge of the second area 32. In the direction of the thickness of the current collector 100, a thickness h1 of the insulating layer 230 and a thickness h2 of the first active layer 210 satisfy the formula 0<h1≤1.1*h2.

Furthermore, the first active layer 210 is also arranged on the third area 51 of the second metal layer 50. The insulating layer 230 is also arranged on the third area 51 and connected to an edge of the fourth area 52.

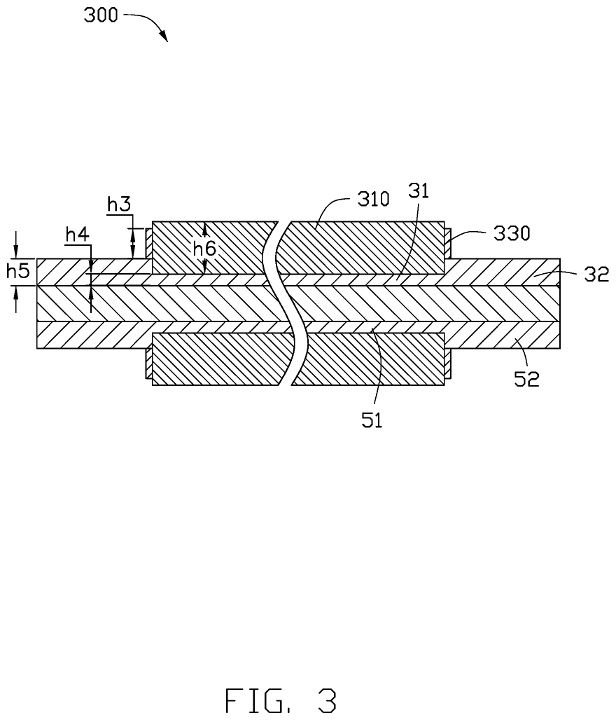

FIG. 3 illustrate another embodiment of a positive electrode plate 300. Different from the positive electrode plate 200, the first active layer 310 is arranged on the first area 31 and connected to an edge of the second area 32, that is, the first active layer 310 completely covers the first area 31, the insulating layer 330 is arranged on the second area 32 and connected to a side of the first active layer 310 adjacent to the second area 32. In the direction of the thickness of the current collector 100, a thickness h3 of the insulating layer 330, a thickness h4 of the first area 31, a thickness h5 of the second area 32, and a thickness h6 of the first active layer 310 satisfy the formula 0<h3≤1.1*(h4+h6−h5).

Furthermore, the first active layer 310 is also arranged on the third area 51 and connected to an edge of the fourth area 52, that is, the first active layer 310 completely covers the third area 51. The insulating layer 330 is also arranged on the fourth area 52 and connected to a side of the first active layer 310 adjacent to the fourth area 52.

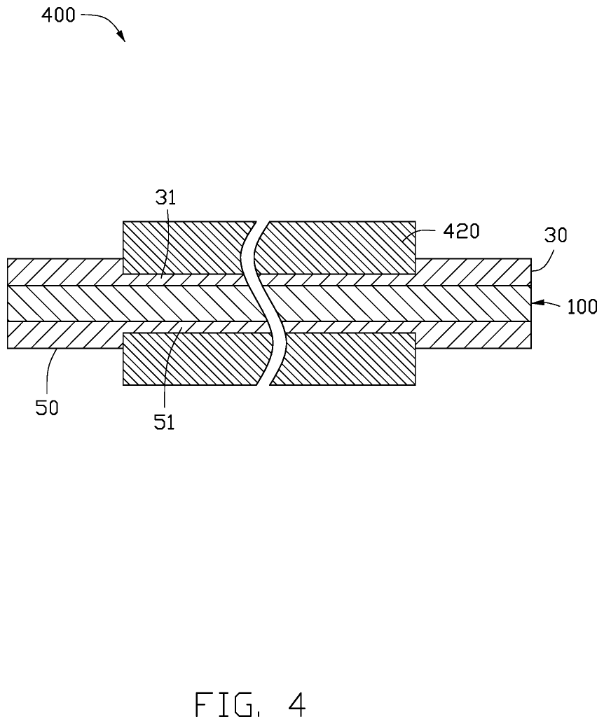

FIG. 4 illustrates an embodiment of a negative electrode plate 400. The negative electrode plate 400 includes the current collector 100 and a second active layer 420 arranged on the current collector 100. The second active layer 420 is a negative active material layer. The negative active material layer can be formed on the surface of the current collector 100 by processes including coating, drying, and cooling. The second active layer 420 is arranged on the first area 31 of the first metal layer 30, and completely covers the first area 31.

Furthermore, the second active layer 420 is arranged on the third area 51 of the second metal layer 50, and completely covers the third area 51.

An embodiment of a battery cell comprises a first electrode plate, a second electrode plate, a separator, a first electrode tab, and a second electrode tab. The separator is arranged between the first electrode plate and the second electrode plate. The first electrode plate and the second electrode plate are stacked or wound to form the battery cell. In an alternative embodiment, the first electrode plate can be the positive electrode plate(s) 200 or 300, the second electrode plate can be the negative electrode plate 400. The first electrode tab is arranged on an edge of the second area of the first electrode plate, or the second area can be cut to form the first electrode tab, the first electrode tab is configured to conduct electrons of the first metal layer. The second electrode tab is arranged on an edge of the fourth area of the second electrode plate, or the fourth area can be cut to form the second electrode tab, the second electrode tab is configured to conduct electrons of the second metal layer. In the battery cell, the side of the second active layer of the second electrode plate adjacent to the second electrode tab is not provided with the insulating layer. In an alternative embodiment, the side of the second active layer of the second electrode plate adjacent to the second electrode tab can be provided with the insulating layer. In manufacture, the battery cell is further filled with electrolyte, then encapsulated and formatted to obtain the finished battery.

### Embodiment 1

Positive electrode plate preparation: Al layers were formed on two opposite surfaces of the PET film (thickness of 12 um) by vacuum vapor deposition to form the positive current collector. The thicknesses of the first area and the third area of the Al layer were both 0.36 um, the thicknesses of the second area and the fourth area of the Al layer were both 1 um. Active material comprising LiCoO₂ was coated on the first area and the third area of the positive current collector, the insulating layer (width of 5 mm) was coated on the second area and the fourth area of the positive current collector, and the insulating layer was connected to the LiCoO₂ active material layer. After drying, forming the electrode tab, and cutting, the positive electrode plate was obtained.

Negative electrode plate preparation: active material comprising graphite was coated on the Cu foil. The Cu foil functioned as the negative current corrector. After drying, cooling, forming the electrode tab, and cutting, the negative electrode plate was obtained.

Battery cell preparation: the isolation film was arranged between the positive electrode plate and the negative electrode plate, then the electrode plates were wound to form the dry battery cell. Electrode tabs were soldered to electrode tab areas to obtain the dry battery cell. The dry battery cell was filled with electrolyte, encapsulated, and formatted to form the battery cell.

### Embodiment 2

Positive electrode plate preparation: the thicknesses of the second area and the fourth area of the Al layer were both 5 um. Other steps were the same as those of the embodiment 1.

Negative electrode plate preparation: steps were the same as those of the embodiment 1.

Battery cell preparation: steps were the same as those of the embodiment 1.

### Embodiment 3

Positive electrode plate preparation: the thicknesses of the second area and the fourth area of the Al layer were both 10 um. Other steps were the same as those of the embodiment 1.

Negative electrode plate preparation: steps were the same as those of the embodiment 1.

Battery cell preparation: steps were the same as those of the embodiment 1.

### Embodiment 4

Positive electrode plate preparation: the thicknesses of the second area and the fourth area of the Al layer were both 15 um. Other steps were the same as those of the embodiment 1.

Negative electrode plate preparation: steps were the same as those of the embodiment 1.

Battery cell preparation: steps were the same as those of the embodiment 1.

### Embodiment 5

Positive electrode plate preparation: the thicknesses of the second area and the fourth area of the Al layer were both 20 um. Other steps were the same as those of the embodiment 1.

Negative electrode plate preparation: steps were the same as those of the embodiment 1.

Battery cell preparation: steps were the same as those of the embodiment 1.

### Comparative Embodiment 1

Positive electrode plate preparation: Al layers (thickness of 0.36 um) were formed on two opposite surfaces of the PET film (thickness of 12 um) by vacuum vapor deposition to form the positive current collector. Active material comprising LiCoO₂ was coated on the first area and the third area of the positive current collector, the insulating layer (width of 5 mm) was coated on the second area and the fourth area of the positive current collector, and the insulating layer was connected to the LiCoO₂ active material layer. After drying, forming the electrode tab, and cutting, the positive electrode plate was obtained.

Negative electrode plate preparation: steps were the same as those of the embodiment 1.

Battery cell preparation: steps were the same as those of the embodiment 1.

Resistance of the electrode tab and energy density loss (Ved loss) of each battery cell prepared by embodiments 1-5 and comparative embodiment 1 were tested. The resistance of the electrode tab was calculated by Ohm's law. The Ved loss was calculated by formula increase value of thickness of the second area*number of layers of the electrode tabs/(increase value of thickness of the second area*number of layers of the electrode tabs+length of the battery cell). The conditions of preparation in embodiments 1-5 and comparative embodiment 1 and the result of test are shown in Table 1.

TABLE 1

| | Thickness of | Layers of the | Length of the | Resistance of the | VED |
|---|---|---|---|---|---|
| | the second area | electrode tabs | battery cell (mm) | electrode tab(mohm) | loss |
| Embodiment | 1 um | 9 | 74 | 1.61 | 0.02% |
| 1 | | | | | |
| Embodiment | 5 um | 9 | 74 | 0.32 | 0.12% |
| 2 | | | | | |
| Embodiment | 10 um | 9 | 74 | 0.16 | 0.24% |
| 3 | | | | | |
| Embodiment | 15 um | 9 | 74 | 0.11 | 0.36% |
| 4 | | | | | |
| Embodiment | 20 um | 9 | 74 | 0.08 | 0.48% |
| 5 | | | | | |
| Comparative | 0.36 um | 9 | 74 | 4.48 | 0% |
| embodiment | | | | | |

Table 1 shows that, in comparison to the battery cells prepared by comparative embodiment 1, each of the electrode tabs of the battery cells prepared by embodiments 1-5 has a smaller resistance, which is due to the increase of the thickness of the second and fourth areas of the Al layer where the electrode tabs are formed.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A current collector comprising:
a polymer layer, comprising a first surface and a second surface opposite to the first surface; and
a first metal layer, arranged on the first surface, and comprising a first area and a second area connected to the first area;
wherein in a direction of a thickness of the current collector, a thickness of the second area is greater than a thickness of the first area.

2. The current collector of claim 1, wherein the current collector further comprises a second metal layer arranged on the second surface, the second metal layer comprises a third area and a fourth area connected to the third area, in the direction of the thickness of the current collector, a thickness of the fourth area is greater than a thickness of the third area.

3. The current collector of claim 1, wherein the thickness of the second area is in a range from 1 um to 20 um, the thickness of the first area is in a range from 0.1 um to 5 um.

4. The current collector of claim 3, wherein the thickness of the second area is in a range from 2 um to 8 um.

5. The current collector of claim 1, wherein the first area is configured for providing active materials, the second area is configured to be cut into an electrode tab.

6. An electrode plate, comprising:
a current collector, comprising:
a polymer layer, comprising a first surface and a second surface opposite to the first surface, and
a first metal layer, arranged on the first surface, and comprising a first area and a second area connected to the first area; and
a first active layer arranged on the first area;
wherein in a direction of a thickness of the current collector, a thickness of the second area is greater than a thickness of the first area.

7. The electrode plate of claim 6, wherein the current collector further comprises a second metal layer arranged on the second surface, the second metal layer comprises a third area and a fourth area connected to the third area, in the direction of the thickness of the current collector, a thickness of the fourth area is greater than a thickness of the third area.

8. The electrode plate of claim 6, wherein the thickness of the second area is in a range from 1 um to 20 um, the thickness of the first area is in a range from 0.1 um to 5 um.

9. The electrode plate of claim 8, wherein the thickness of the second area is in a range from 2 um to 8 um.

10. The electrode plate of claim 6, wherein the first area is configured for providing active materials, the second area is configured to be cut into an electrode tab.

11. The electrode plate of claim 6, wherein the electrode plate further comprises an insulating layer, the insulating layer is arranged on a side of the first active layer adjacent to the second area.

12. The electrode plate of claim 11, wherein the insulating layer is arranged on the first area and coupled to an edge of the second area.

13. The electrode plate of claim 12, wherein the insulating layer has a thickness of h1 and the first active layer has a thickness of h2, wherein 0<h1≤1.1*h2.

14. The electrode plate of claim 11, wherein the insulating layer is arranged on the second area.

15. The electrode plate of claim 14, wherein the insulating layer has a thickness of h3, the first area has a thickness of h4, the second area has a thickness of h5, and the first active layer has a thickness of h6, wherein 0<h3≤1.1*(h4+h6−h5).

16. A battery cell, comprising:
a first electrode plate comprising a current collector and a first active layer, wherein the current collector comprises:
a polymer layer, comprising a first surface and a second surface opposite to the first surface, and
a first metal layer, arranged on the first surface, and the first metal layer comprises a first area and a second area connected to the first area;
wherein the first active layer is arranged on the first area;
a second electrode plate;
a separator arranged between the first electrode plate and the second electrode plate, the first electrode plate and the second electrode plate being stacked or wound to form the battery cell;
a first electrode tab arranged on the second area of the first electrode plate; and
a second electrode tab arranged on the second electrode plate;
wherein in a direction of a thickness of the current collector, a thickness of the second area is greater than a thickness of the first area.

17. The battery cell of claim 16, wherein the current collector further comprises a second metal layer arranged on the second surface, the second metal layer comprises a third area and a fourth area connected to the third area, in the direction of the thickness of the current collector, a thickness of the fourth area is greater than a thickness of the third area.

18. The battery cell of claim 16, wherein the electrode plate further comprises an insulating layer, the insulating layer is arranged on a side of the first active layer adjacent to the second area.

19. The battery cell of claim 16, wherein a surface of the second electrode plate is provided with a second active layer, a side of the second active layer adjacent to the second electrode tab is not provided with a second insulating layer.

20. The battery cell of claim 16, wherein the first electrode tab is formed by cutting the second area.
